(19) United States
(12) Patent Application Publication
(10) Pub. No.: US 2015/0032621 A1
(43) Pub. Date: Jan. 29, 2015

(54) METHOD AND SYSTEM FOR PROXIMITY FRAUD CONTROL

(71) Applicant: MASTERCARD INTERNATIONAL INCORPORATED, Purchase, NY (US)

(72) Inventors: Anindeep Kar, St. Charles, MO (US); Surya D. Bhattacharyya, St. Louis, MO (US); Kristofer Perez, New York, NY (US); Gregory Williamson, Stamford, CT (US)

(73) Assignee: MASTERCARD INTERNATIONAL INCORPORATED, Purchase, NY (US)

(21) Appl. No.: 13/949,850

(22) Filed: Jul. 24, 2013

(51) Int. Cl. G06Q 20/40

(52) U.S. Cl. CPC G06Q 20/4016
USPC 705/44

(57) ABSTRACT

A method for authenticating a user in a payment transaction using a computing device includes: storing location data entries, each entry including a geographic location of a mobile device and a time; receiving an authorization request for a payment transaction, the request including an account identifier, location identifier, and authorization time; identifying a specific data entry where the included time is within a predetermined period of time of the authorization time; when the location included in the specific data entry is indicative of the mobile device being not present at the location of the location identifier, transmitting a request to a computing device associated with the account identifier for action by a user to prove their identity; receiving, data conveying the action taken by the user; and authenticating the user based on the received data and authentication information associated with a payment account corresponding to the account identifier.

### FIELD

The present disclosure relates to the authentication of payment transactions, specifically authenticating transactions based on geolocation of a mobile device and additional authentication data received from a cardholder.

### BACKGROUND

Credit card fraud and other payment card fraud can cost consumers, merchants, issuers, acquirers, and payment networks both time and resources. As technology develops, many payment networks and other entities have begun to use mobile devices to provide additional security against fraud. For example, some methods and systems use the geographic location of a mobile device associated with a cardholder, which is identified during authorization and compared to the location of the transaction, such as described in Fourez, U.S. patent application Ser. No. 12/544,009, entitled “Location Controls on Payment Card Transactions,” filed Aug. 19, 2009, which is herein incorporated by reference in its entirety. Other systems and methods similarly compare the location of the transaction at the time of authorization to previously-obtained locations of a mobile device, such as those described in Stevens, U.S. Pat. No. 7,487,170, entitled “Location Information for Avoiding Unwanted Communications Systems and Methods,” issued on Feb. 3, 2009, which is herein incorporated by reference in its entirety.

However, such systems and methods only utilize the geographic location of the mobile device for authentication of the payment transaction. Such systems would not prevent fraud in instances where the perpetrator of the fraud is in possession of the mobile device. In cases where a mobile device includes a wallet application, the fraudster would be in possession of both the payment card or cards and the form of authentication. In addition, such systems require the cardholder to be in possession of the mobile device at the time of authorization. This could lead to unnecessary denials of authorization for a cardholder involved in a genuine transaction in instances where a cardholder left their mobile device at home or in their vehicle, let a family member or friend use their payment card, or if their mobile device was powered down.

Thus, there is a need for a technical solution for providing fraud control based on geolocation that is effective in instances where a mobile device is unavailable or has been compromised.

### SUMMARY

The present disclosure provides a description of a system and method for the authentication of a user in a payment transaction using a computing device.

A method for authenticating a user in a payment transaction using a computing device includes: storing, in a database, a plurality of location data entries, wherein each location data entry includes data related to the location of a mobile device including a geographic location of the related mobile device and a time and/or date at which the corresponding geographic location was identified; receiving, by a receiving device, an authorization request for a payment transaction, wherein the authorization request includes at least an account identifier, a location identifier, and an authorization time and/or date; identifying, in the database, a specific location data entry where the included time and/or date is within a predetermined period of time of the authorization time and/or date; when the geographic location included in the specific location data entry is indicative of the mobile device being not present at a point-of-sale corresponding to the location identifier, transmitting, by a transmitting device, a request to a computing device associated with the account identifier for action by a user of the computing device to prove an identity of the user; receiving, by the receiving device, data conveying the action taken by the user of the computing device to prove the identity of the user; and authenticating, by a processing device, the user based on the received data conveying the action taken by the user to prove the identity of the user and authentication information associated with a payment account corresponding to the account identifier.

A system for authenticating a user in a payment transaction using a computing device includes a database, a receiving device, a processing device, and a transmitting device. The database is configured to store a plurality of location data entries, wherein each location data entry includes data related to the location of a mobile device including a geographic location of the related mobile device and a time and/or date at which the corresponding geographic location was identified. The receiving device is configured to receive an authorization request for a payment transaction, wherein the authorization request includes at least an account identifier, a location identifier, and an authorization time and/or date. The processing device is configured to identify, in the database, a specific location data entry where the included time and/or date is within a predetermined period of time of the authorization time and/or date. The transmitting device is configured to, when the geographic location included in the specific location data entry is indicative of the mobile device being not present at a point-of-sale corresponding to the location identifier, transmit a request to a computing device associated with the account identifier for action by a user of the computing device to prove an identity of the user. The receiving device is further configured to receive data conveying the action taken by the user of the computing device to prove the identity of the user, and the processing device is further configured to authenticate—the user based on the received data conveying the action taken by the user to prove the identity of the user and authentication information associated with a payment account corresponding to the account identifier.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the authentication of a user in a payment transaction using a computing device in accordance with exemplary embodiments.

FIG. 2 is a block diagram illustrating the processing server of FIG. 1 for the authentication of a user in a payment transaction in accordance with exemplary embodiments.

FIGS. 3A and 3B are a flow diagram illustrating a method for the authorizing and authentication a user in a payment transaction in accordance with exemplary embodiments.

FIG. 4 is a flow diagram illustrating a method for authorizing a payment transaction using geolocation and authentication of a user of a computing device in accordance with exemplary embodiments.

FIG. 5 is a flow chart illustrating an exemplary method for authenticating a user in a payment transaction using a computing device in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Authenticating a User in a Payment Transaction

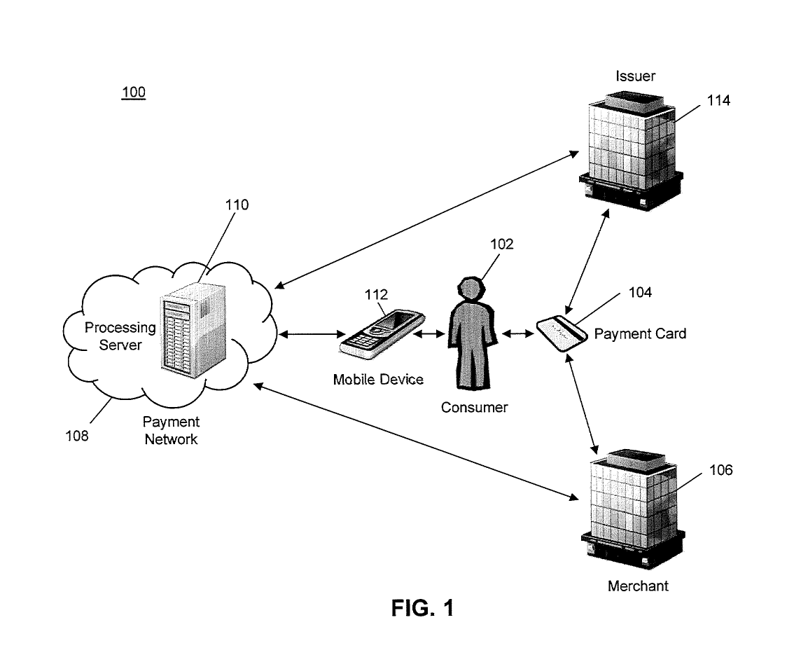

FIG. 1 illustrates a system 100 for authenticating a user in a payment transaction based on geolocation of a mobile device and additional authentication data received from the user via a computing device.

A consumer 102 may use a payment card 104 in order to engage in a payment transaction with a merchant 106. The consumer 102 may present the payment card 104 for payment as a card-present transaction, such as by providing the physical payment card 104 to an employee of the merchant 106 at a point-of-sale, or as a card-not-present transaction, such as by providing a payment card number associated with the payment card in another form. For example, the consumer 102 may be in possession of a mobile device 112, which may include a wallet application or otherwise be used to present payment details associated with the payment card 104 to the merchant 106. Additional methods and systems for providing payment details associated with a payment card to a merchant will be apparent to persons having skill in the relevant art.

The merchant 106 may, after receiving the payment information from the consumer 102, generate an authorization request for the payment transaction including the payment information. The merchant 106 may then submit the authorization request to a payment network 108 for processing. The payment network 108 may include a processing server 110, discussed in more detail below, configured to authenticate the payment card 104 and the consumer 102 involved in the payment transaction.

The processing server 110 may store location information including the geographic location of the mobile device 112 in a location database, discussed in more detail below. The mobile device 112 may be any type of device suitable for performing the functions as disclosed herein, such as a cellphone, smartphone, tablet computer, notebook computer, etc. The location information may include at least the geographic location of the mobile device 112 and a time and/or date at which the corresponding geographic location was identified. In some instances, the processing server 110 may be configured to identify (e.g., receive) an updated geographic location of the mobile device 112 at or near the time of the receipt of the authorization request for the payment transaction. Methods for obtaining the geographic location of a mobile device will be apparent to persons having skill in the relevant art and may include use of a global positioning system, wireless network, cellular system triangulation, and an application program executed by the mobile device.

The processing server 110 may identify the geographic location of the mobile device 112 as not being in proximity to the merchant 106 at the time of the payment transaction, or otherwise being indicative of the mobile device 112 not being present at the time of the transaction. As the mobile device 112 not being in proximity of the merchant 106 may indicate a fraudulent transaction, but not necessarily be dispositive of fraud (e.g., the consumer 102 may have left the mobile device 112 in a vehicle or at home, it may be powered down, etc.), the processing server 110 may submit a request to a computing device associated with the consumer 102 for action by the consumer 102 to prove their identity.

The computing device may be the mobile device 112, or any other computing device suitable for performing the functions as discussed herein. For example, the consumer 102 may use a computing device (e.g., an Internet-connected computer) to initiate the financial transaction, and thus the request from the processing server 110 may be submitted to the computing device. The consumer 102 may receive the request via the computing device and may then provide additional authentication data to prove his/her identity. The additional authentication data may include an answer to a security question, a code sent to the computing device to be input at the point-of-sale, a personal identification number, a password, biometric information (e.g., a fingerprint), or any other suitable information that will be apparent to persons having skill in the relevant art.

The computing device may then transmit the consumer-supplied additional authentication information to the processing server 110. In some instances, the additional authentication information may be transmitted to the processing server 110 by the merchant 106, such as in instances where the consumer 102 supplies authentication data to the point-of-sale. The processing server 110 may compare the received authentication data with authentication data stored associated with the consumer 102 to authenticate the identity of the consumer 102 as the cardholder or otherwise authorized user of the payment card 104. If the comparison fails (e.g., the authentication is unsuccessful), the processing server 110 may deny the transaction, and the payment network 108 may submit an authorization response to the merchant 106 indicating denial of the payment transaction. If the comparison is successful, the processing server 110 may forward the authorization request to the issuer 114, which may approve or deny the payment transaction using systems and methods apparent to persons having skill in the relevant art.

Processing Device

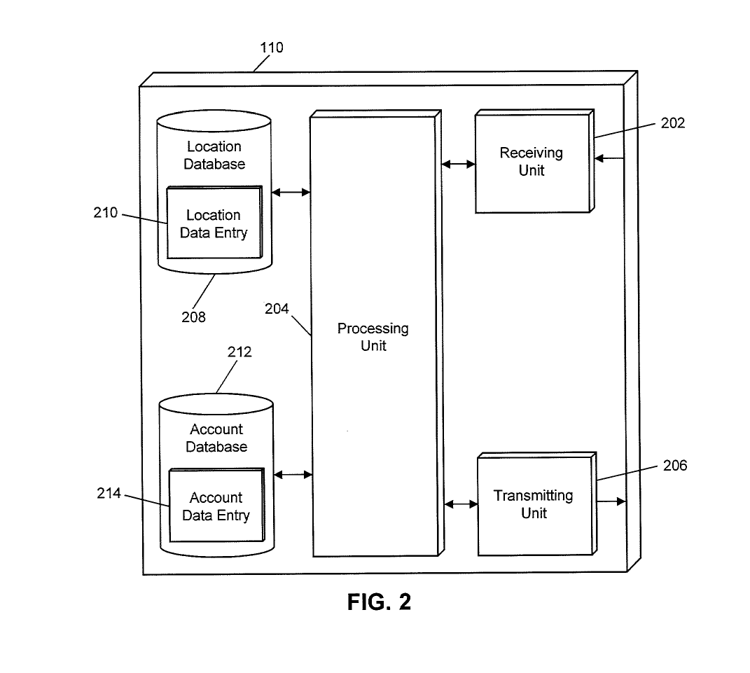

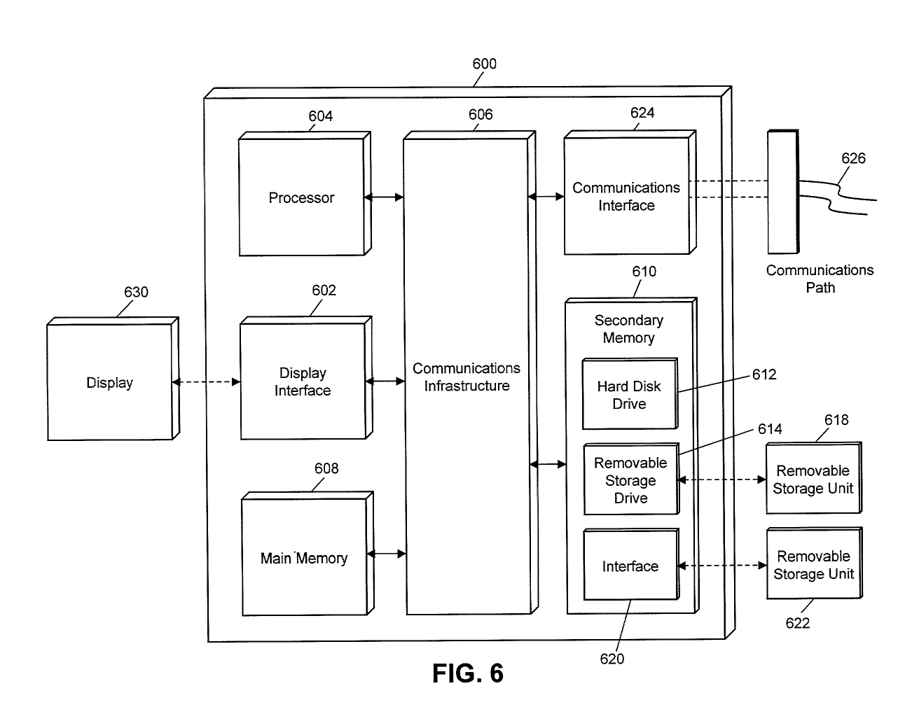

FIG. 2 illustrates an embodiment of the processing server 110 of the system 100. It will be apparent to persons having skill in the relevant art that the embodiment of the processing server 116 illustrated in FIG. 2 is provided as illustration only and may not be exhaustive to all possible configurations of the processing server 110 suitable for performing the functions as discussed herein. For example, the computer system 600 illustrated in FIG. 6 and discussed in more detail below may be a suitable configuration of the processing server 110.

The processing server 110 may include a receiving unit 202. The receiving unit 202 may be configured to interface (e.g., connect, communicate, etc.) with one or more networks in order to receive data, information, etc. The receiving unit 202 may receive location information for the mobile device 112, such as the geographic location of the mobile device 112 and the corresponding time and/or date at which the geographic location was identified. In some embodiments, the receiving unit 202 may receive data directly from the mobile device 112, which may be analyzed by a processing unit 204 to identify the geographic location of the mobile device 112.

The processing unit 204 may store the location information as a location data entry 210 in a location database 208. Each location data entry may store data related to the location of the mobile device 112 and include at least the geographic location of the mobile device and the time and/or date at which the corresponding geographic location was identified. The geographic location may be represented in latitude and longitude or any other representation suitable for performing the functions as disclosed herein as will be apparent to persons having skill in the relevant art.

The receiving unit 202 may also be configured to receive authorization requests for payment transactions. The authorization request may include at least an account identifier, a location identifier, and an authorization time and/or date. The account identifier may be a value suitable for identification of a payment account (e.g., corresponding to the payment card 104) for use in funding the payment transaction. The location identifier may be a value suitable for identifying the geographic location at which the transaction is taking place (e.g., at the merchant 106). The location identifier may be represented by latitude and longitude, or any other suitable system, or may correspond to the merchant 106, which may be used to find the geographic location of the merchant 106 via a look-up table or other similar system or method. The authorization time and/or date at which the transaction was initiated, the authorization request was submitted, or any other time indicative of the payment transaction suitable for use in performing the functions as discussed herein.

The processing unit 204 may be configured to identify, in the location database 208, a specific location data entry 210 where the time and/or date included in the specific location data entry 210 corresponds to the authorization time and/or date included in the authorization request. The processing unit 204 may then compare the geographic location in the specific location data entry 210 with the location identifier included in the authorization request. If the comparison is indicative of the mobile device 112 being not present at the point-of-sale where the transaction takes place, then the processing unit 204 may identify an account data entry 214 in the account database 212 corresponding to the account identifier included in the authorization request.

The account database 212 may include a plurality of account data entries 214, wherein each account data entry 214 may include data associated with a consumer (e.g., the consumer 102) and may include an account identifier, a mobile device and/or computing device identifier, and authentication data. The account identifier may be a value suitable for identifying a payment account associated with the related consumer 102. The mobile device identifier and/or computing device identifier may be an identifier associated with the mobile device 112 or computing device associated with the related consumer 102 that may be used to provide additional authentication data. The authentication data may be additional data used to authenticate the consumer 102 as the consumer related with the corresponding account data entry 214.

The processing server 110 may also include a transmitting unit 206. The transmitting unit 206 may be configured to transmit a request for action by a user of the mobile device 112 or computing device associated with the mobile device and/or computing device identifier included in the account data entry 214 associated with the account identifier included in the authorization request. The user of the device may provide the additional data consistent with the requested action, which may be transmitted to the processing server 110 and received by the receiving unit 202.

The processing unit 204 may compared the received data with the authentication data included in the account data entry 214. If the comparison is successful (e.g., the consumer 102 provides data to prove their identity as the cardholder of the associated payment account), then the transmitting unit 206 may forward the authorization request and/or an indication of successful authentication to the issuer 114 and/or the payment network 108 for processing. The payment transaction may then be processed using systems and methods apparent to persons having skill in the relevant art. As part of the processing, the receiving unit 202 may receive an authorization response indicating approval or denial of the payment transaction, which may be forwarded by the transmitting unit 206 to the merchant 106.

If the comparison of the received authentication data was unsuccessful, then transmitting unit 206 may transmit an authorization response indicating the denial of the payment transaction to the merchant 106. In some embodiments, the transmitting unit 206 may forward the authorization request to the issuer 114 indicating the unsuccessful authentication. In some instances, the processing server 110 may be configured to transmit the authorization request along with a fraud score based on the comparison of the received authentication data. In further instances, the fraud score may be transmitted to the issuer 114 regardless of the successful or unsuccessful authentication of the consumer 102 based on the received data.

### Method for Authenticating and Authorization a Payment Transaction

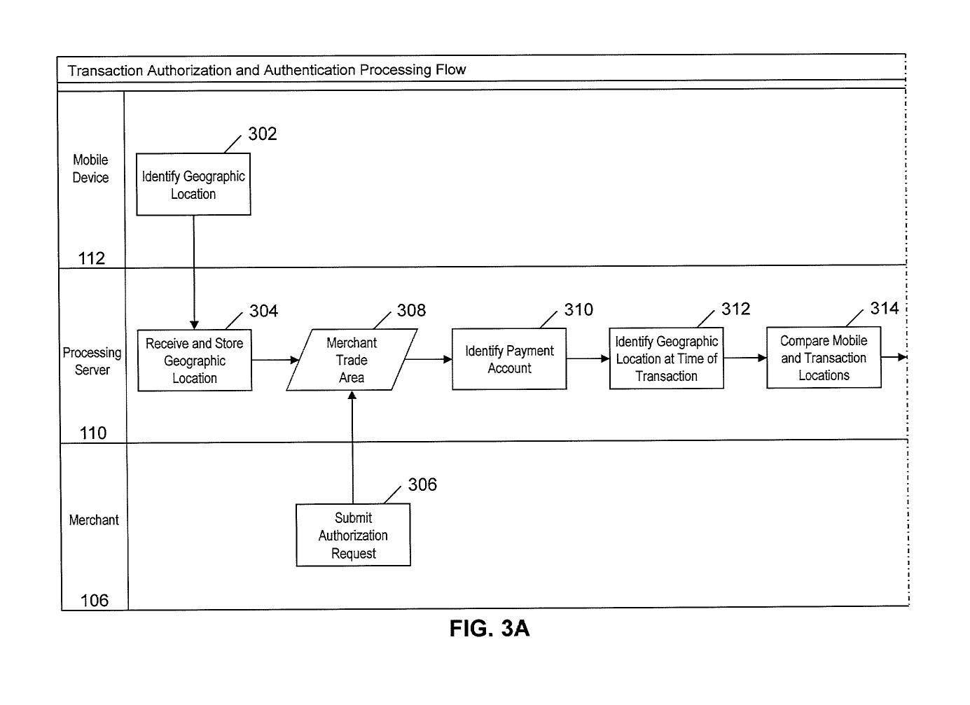

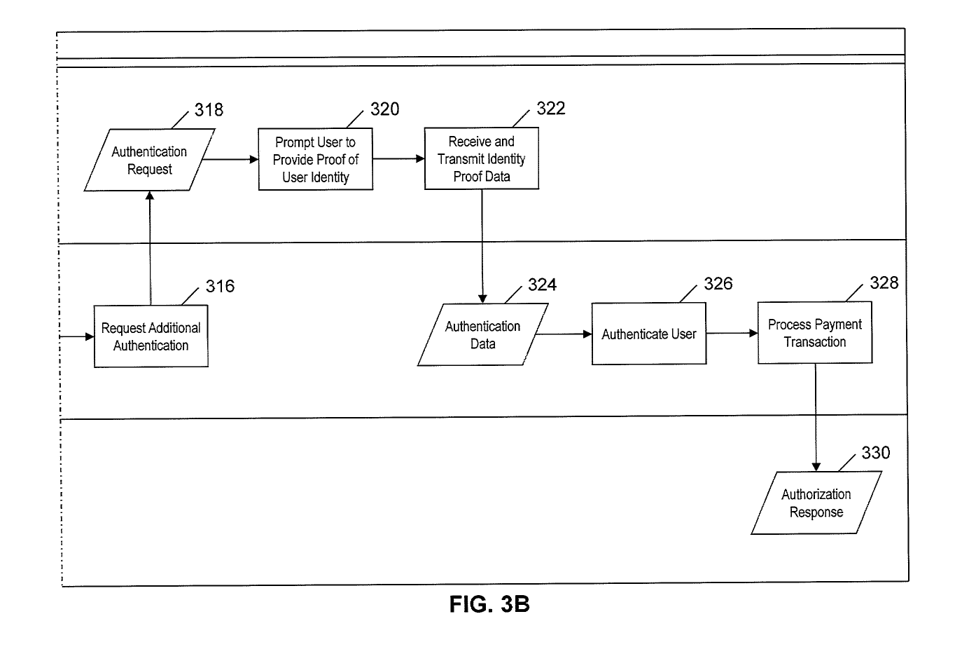

FIG. 3 illustrates a method 300 for the authentication of the consumer 102 and the processing of authorization of a payment transaction using the system 100 of FIG. 1.

In step 302, the mobile device 112 may identify its geographic location at a time and/or date. Methods and systems for identifying the geographic location of the mobile device 112 will be apparent to persons having skill in the relevant art and may include using a global positioning system, wireless network, cellular system triangulation, an application program executed by the mobile device 112, etc. In step 304, the processing server 110 may receive the identified geographic location and corresponding time and/or date and store the received information as a location data entry 210 in the location database 208. In some embodiments, the mobile device 112 may transmit its geographic location to a third party, such as a mobile network operator, which may forward the geographic location data to the processing server 110. Other methods for obtaining the geographic location of the mobile device 112 by the processing server 110 will be apparent to persons having skill in the relevant art.

In step 306, the merchant 106 may submit an authorization request for a payment transaction including the consumer 102 associated with the mobile device 112. The authorization request may include an account identifier associated with the payment card 104 used to fund the payment transaction, a location identifier corresponding to the location of the merchant 106, and an authorization time and/or date corresponding to the time of the payment transaction. The authorization request may be submitted to the processing server 110 (e.g., via the payment network 108), which may be received in step 308.

In step 310, the processing server 110 may identify the payment account associated with the account identifier included in the authorization request. Identifying the payment account may include identifying an account data entry 214 including the account identifier or another identifier corresponding to the account identifier. At step 312, the processing server 112 may identify the geographic location of the mobile device 112 at the time of the payment transaction by identifying a specific location data entry 210 in the location database 208 where the included time and/or date corresponds to the authorization time and/or date.

In step 314, the processing server 110 may compare the geographic location of the mobile device 112 with the geographic location of the payment transaction based on the location identifier included in the authorization request. If the comparison is indicative of the mobile device 112 not being present at the payment transaction, then the processing server 110 may, in step 316, transmit a request for additional authentication information to the mobile device 112 or another computing device associated with the payment account as identified in step 310.

In step 316, the mobile device 112 or computing device may receive the request for additional information. The request may include a request for an action to be performed by the user of the device to prove the identity of the user as an authorized user of the payment account used in the payment transaction. In step 320, the mobile device 112 or other computing device may prompt the user to provide the proof of their identity as an authorized user, such as providing biometric information, a personal identification number, a password, etc. The mobile device 112 or computing device may receive the identify proof data as input by the user, and may transmit the data to the processing server 110 in step 322.

In step 324, the processing server 110 may receive the additional authentication data as proof of the consumer 102's identity from the computing device and/or the mobile device 112. In step 326, the processing server 110 may authenticate the consumer 102 as an authorized user of the payment account based on the identity proof data and authentication data included in the account data entry 214 associated with the payment account used to fund the payment transaction. Then, in step 328, the processing server 110 may process the payment transaction. Processing the payment transaction may include forwarding the authorization request to the issuer 114 including the results of the authentication performed in step 326 (e.g., which may be represented in a fraud score) and receiving an authorization response from the issuer 114 indicating approval or denial of the payment transaction.

In step 330, the processing server 110 may forward the authorization response to the merchant 106, which may be received by the merchant 106 for finalization of the payment transaction. In some embodiments, the processing server 110 may also transmit a notification to the mobile device 112 and/or the computing device indicating the results of the authentication of the identity of the user.

### Method for Processing Authentication of a User of a Payment Transaction

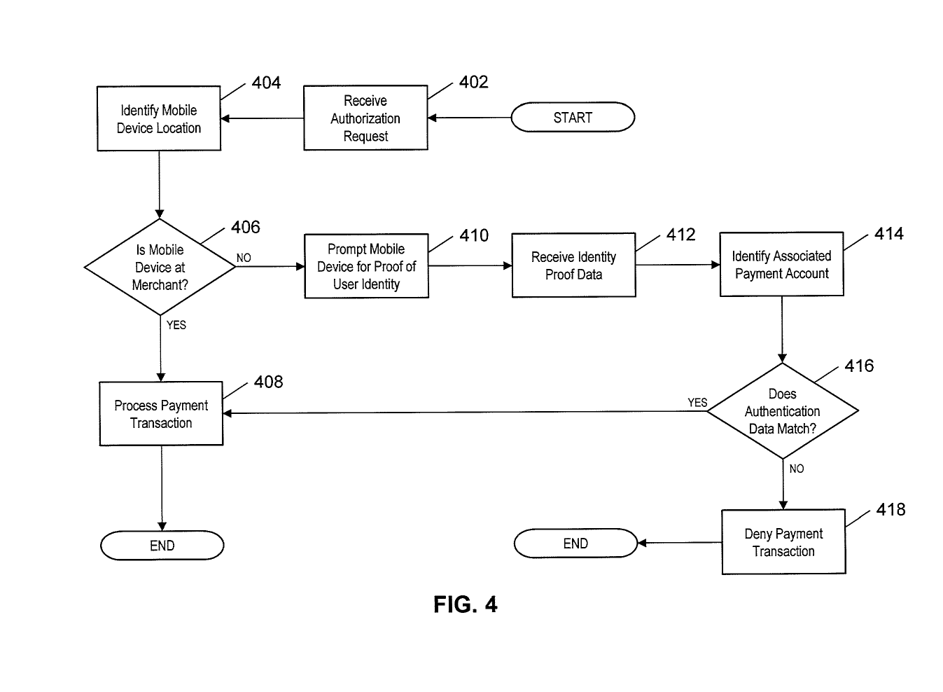

FIG. 4 illustrates a method for the authentication of the consumer 102 as an authenticated user of the payment card 104 by the processing server 110.

In step 402, the receiving unit 202 of the processing server 110 may receive the authorization request for the payment transaction including at least an account identifier, a location identifier, and an authorization time and/or date. In step 404, the processing server 110 may identify the geographic location of the mobile device 112 associated with the payment account corresponding to the account identifier. In some embodiments, the mobile device 112 may be identified based on an account data entry 214 in the account database 212 including the account identifier.

In step 406, the processing unit 204 of the processing server 110 may determine if the mobile device 112 is located at the physical location of the merchant 106 based on a comparison of the identified geographic location of the mobile device 112 and a location corresponding to the location identifier included in the authorization request. In some instances, the comparison may be successful if the geographic location of the mobile device 112 is identified as being within a predetermined distance from the merchant 106 involved in the payment transaction. In further instances, the predetermined distances may vary, such as based on the merchant 106 and/or the geographic location. For example, the predetermined distances may be larger for a large retail store, and may be smaller for a small specialty store.

If the comparison indicates the mobile device 112 being located at the location at which the transaction is taking place, then, in step 408, the processing unit 204 of the processing server 110 may process the payment transaction using methods and systems apparent to persons having skill in the relevant art. If the comparison in step 406 indicates the mobile device 112 as not being present at the location of the payment transaction, then, in step 410, the transmitting unit 206 of the processing server 110 may transmit a prompt to the mobile device 112 or another computing device associated with the payment account involved in the payment transaction to provide proof of the identity of the user of the mobile device 112 and/or computing device. In some instances, the computing device may be a computing device used to initiated the payment transaction, such as a computer used to initiate an e-commerce transaction via the Internet.

In step 412, the receiving unit 202 of the processing server 110 may receive identity proof data from the computing device and/or mobile device 112. In step 414, the processing unit 204 may identify the associated payment account via an account data entry 214 in the account database 212 including the account identifier included in the authorization request. The processing unit 204 may then compare the received identity proof data with authentication data included in the account data entry 214 in step 416. If the identity proof data matches the authentication data, then the process may proceed to step 408 to process the payment transaction. In such an instance, the processing of the payment transaction may include forwarding the authorization request to the issuer 114 of the payment card 104 including the matched identity proof data and/or a fraud score based on at least the matching of the identity proof data with the authentication data.

If the identity proof data does not match the authentication data, then, in step 418, the processing server 110 may deny the payment transaction, such as by transmitting, by the transmitting unit 206, an authorization response indicating denial of the payment transaction to the merchant 106. In some embodiments, the processing server 110 may forward the authorization request to the issuer 114 despite the failure to match the authentication data, but may include an indication of the failure to match the authentication data, such as a fraud score based on at least the failure to match the data. In some embodiments, the transmitting unit 206 may also transmit a notification to the mobile device 112 and/or computing device indicating the successful or unsuccessful outcome of the transaction processing.

### Exemplary Method for Authenticating a User in a Payment Transaction Using a Computing Device

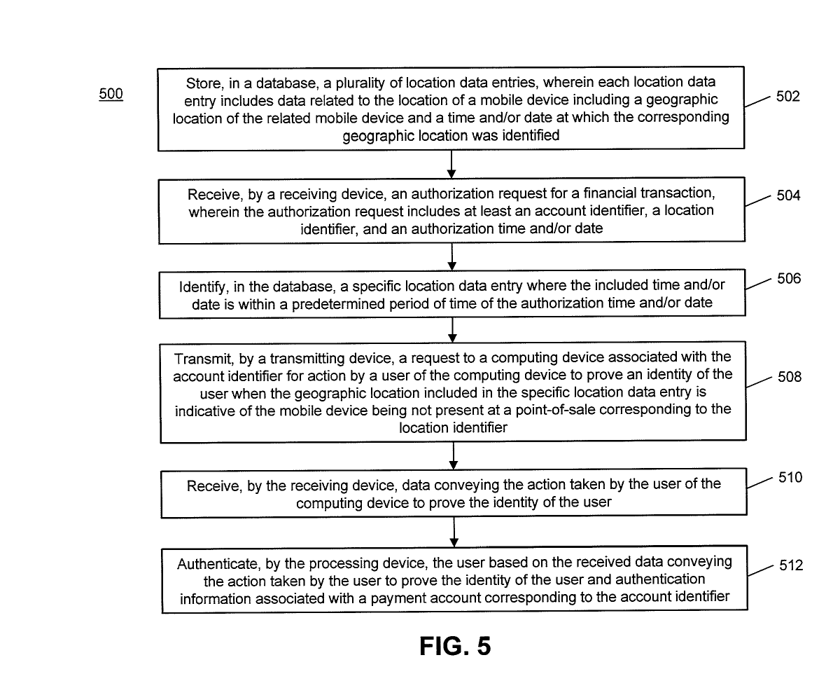

FIG. 5 illustrates a method 500 for authenticating a user involved in a payment transaction using an associated computing device.

In step 502, a database (e.g., the location database 208) may store a plurality of location data entries (e.g., the location data entries 210), wherein each location data entry 210 includes data related to the location of a mobile device (e.g., the mobile device 112) including a geographic location of the related mobile device 112 and a time and/or date at which the corresponding geographic location was identifier. In some embodiments, the geographic location of the related mobile device 112 may be identified using at least one of: a global positioning system, wireless network, cellular system triangulation, and an application program executed by the related mobile device 112. In a further embodiment, the application program may be a wallet program.

In step 504, a receiving device (e.g., the receiving unit 202) may receive an authorization request for a payment transaction, wherein the authorization request includes at least an account identifier, a location identifier, and an authorization time and/or date. In step 506, a specific location data entry 210 may be identified, in the database 208, where the included time and/or date is within a predetermined period of time of the authorization time and/or date.

In step 508, a transmitting device (e.g., the transmitting unit 206) may transmit a request to a computing device associated with the account identifier for action by a user of the computing device to prove an identity of the user when the geographic location included in the specific location data entry is indicative of the mobile device 112 being not present at a point-of-sale corresponding to the location identifier. In some embodiments, the computing device may be the mobile device 112. In other embodiments, the computing device may be a computing device used to initiate the payment transaction. In one embodiment, the request may include at least a security question associated with the payment account associated with the account identifier.

In step 510, the receiving device 202 may receive data conveying the action taken by the user of the computing device to prove the identity of the user. In some embodiments, data conveying the action taken by the user may include at least one of: an answer to a security question, a code sent to the mobile device 112 or the computing device for input at a point-of-sale corresponding to the location identifier, a personal identification number, a password, and biometric information. In a further embodiment, the biometric information may include a fingerprint.

In step 512, the processing device 205 may authenticate the user based on the received data conveying the action taken by the user to prove the identity of the user and authentication information associated with a payment account corresponding to the account identifier.

In one embodiment, the method 500 further includes transmitting, by the transmitting device 206, the authorization request to an issuer (e.g., the issuer 114) associated with the payment account together with a fraud score based on the received data conveying the action taken by the user to prove the identity of the user, receiving, by the receiving device 202, an authorization response from the issuer 114, and forwarding, by the transmitting device 206, the authorization response in response to the received authorization request. In a further embodiment, the method 500 may even further include transmitting, by the transmitting device 206, a notification to the mobile device 112 indicating one of: successful authentication of the user and unsuccessful authentication of the user.

In another embodiment, the method 500 may further include storing, in an account database (e.g., the account database 212), a plurality of account data entries (e.g., the account data entries 214), wherein each account data entry 214 includes data related to a payment account including at least a payment account identifier, a mobile device identifier, and authentication data. In one further embodiment, each account data entry 214 may further including a computing device identifier. In some further embodiments, the method 500 may even further include the plurality of account data entries 214 including a specific account data entry 214 wherein the included payment account identifier corresponds to the account identifier, the including mobile device identifier is associated with the mobile device 112, and the data conveying the action taken by the user to prove the identity of the user corresponds to the included authentication data.

### Computer System Architecture

FIG. 6 illustrates a computer system 600 in which embodiments of the present disclosure, or portions thereof, may be implemented as computer-readable code. For example, the processing server 110 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, 4, and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments. A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communication infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g. DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3A, 3B, 4, and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for authenticating a user in a payment transaction using a computing device. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for authenticating a user in a payment transaction using a computing device, comprising:
storing, in a database, a plurality of location data entries, wherein each location data entry includes data related to the location of a mobile device including a geographic location of the related mobile device and a time and/or date at which the corresponding geographic location was identified;
receiving, by a receiving device, an authorization request for a payment transaction, wherein the authorization request includes at least an account identifier, a location identifier, and an authorization time and/or date;
identifying, in the database, a specific location data entry where the included time and/or date is within a predetermined period of time of the authorization time and/or date;
when the geographic location included in the specific location data entry is indicative of the mobile device being not present at a point-of-sale corresponding to the location identifier, transmitting, by a transmitting device, a request to a computing device associated with the account identifier for action by a user of the computing device to prove an identity of the user;
receiving, by the receiving device, data conveying the action taken by the user of the computing device to prove the identity of the user; and
authenticating, by a processing device, the user based on the received data conveying the action taken by the user to prove the identity of the user and authentication information associated with a payment account corresponding to the account identifier.

2. The method of claim 1, wherein the data conveying the action taken by the user to prove the identity of the user include at least one of: an answer to a security question; a code sent to the mobile device to be input at the point-of-sale corresponding to the location identifier; personal identification number, a password, and biometric information.

3. The method of claim 2, wherein the biometric information includes a fingerprint.

4. The method of claim 1, wherein the request for action to be taken by the user to prove the identity of the user includes at least a security question associated with the payment account.

5. The method of claim 1, wherein the geographic location of the related mobile device is identified using at least one of: a global positioning system, wireless network, cellular system triangulation, and an application program executed by the related mobile device.

6. The method of claim 5, wherein the application program is a wallet program.

7. The method of claim 1, further comprising:
transmitting, by the transmitting device, the authorization request to an issuer associated with the payment account together with a fraud score based on the received data conveying the action taken by the user to prove the identity of the user;
receiving, by the receiving device, an authorization response from the issuer; and
forwarding, by the transmitting device, the authorization response in response to the received authorization request.

8. The method of claim 7, further comprising:
transmitting, by the transmitting device, a notification to the mobile device and/or the computing device indicating one of: successful authentication of the user and unsuccessful authentication of the user.

9. The method of claim 1, further comprising:
storing, in an account database, a plurality of account data entries, wherein each account data entry includes data related to a payment account including at least a payment account identifier, a mobile device identifier, and authentication data.

10. The method of claim 9, wherein the plurality of account data entries includes a specific account data entry wherein the included payment account identifier corresponds to the account identifier, the included mobile device identifier is associated with the mobile device, and the data conveying the action taken by the user to prove the identity of the user corresponds to the included authentication data.

11. The method of claim 1, wherein the computing device is the mobile device.

12. A system for authenticating a user in a payment transaction using a computing device, comprising:
a database configured to store a plurality of location data entries, wherein each location data entry includes data related to the location of a mobile device including a geographic location of the related mobile device and a time and/or date at which the corresponding geographic location was identified;
a receiving device configured to receive an authorization request for a payment transaction, wherein the authorization request includes at least an account identifier, a location identifier, and an authorization time and/or date;
a processing device configured to identify, in the database, a specific location data entry where the included time and/or date is within a predetermined period of time of the authorization time and/or date; and
a transmitting device configured to, when the geographic location included in the specific location data entry is indicative of the mobile device being not present at a point-of-sale corresponding to the location identifier, transmit a request to a computing device associated with the account identifier for action by a user of the computing device to prove an identity of the user, wherein
the receiving device is further configured to receive data conveying the action taken by the user of the computing device to prove the identity of the user, and
the processing device is configured to the user based on the received data conveying the action taken by the user to prove the identity of the user and authentication information associated with a payment account corresponding to the account identifier.

13. The system of claim 12, wherein the data conveying the action taken by the user to prove the identity of the user include at least one of: an answer to a security question; a code sent to the mobile device to be input at a point-of-sale corresponding to the location identifier; personal identification number, a password, and biometric information.

14. The system of claim 13, wherein the biometric information includes a fingerprint.

15. The system of claim 12, wherein the request for action to be taken by the user to prove the identity of the user includes at least a security question associated with the payment account.

16. The system of claim 12, wherein the geographic location of the related mobile device is identified using at least one of: a global positioning system, wireless network, cellular system triangulation, and an application program executed by the related mobile device.

17. The system of claim 16, wherein the application program is a wallet program.

18. The system of claim 12, wherein
the transmitting device is further configured to transmit the authorization request to an issuer associated with the payment account together with a fraud score based on the received data conveying the action taken by the user to prove the identity of the user;
the receiving device is further configured to receive an authorization response from the issuer, and
the transmitting device is further configured to forward the authorization response in response to the received authorization request.

19. The system of claim 18, wherein
the transmitting device is further configured to transmit a notification to the mobile device and/or the computing device indicating one of: successful authentication of the user and unsuccessful authentication of the user.

20. The system of claim 12, further comprising:
an account database configured to store a plurality of account data entries, wherein each account data entry includes data related to a payment account including at least a payment account identifier, a mobile device identifier, and authentication data.

21. The system of claim 20, wherein the plurality of account data entries includes a specific account data entry wherein the included payment account identifier corresponds to the account identifier, the included mobile device identifier is associated with the mobile device, and the data conveying the action taken by the user to prove the identity of the user corresponds to the included authentication data.

22. The system of claim 12, wherein the computing device is the mobile device.
